(19) United States
(12) Patent Application Publication
(10) Pub. No.: US 2014/0238276 A1
(43) Pub. Date: Aug. 28, 2014

(54) Method for the production of a building material

(71) Applicant: HOLCIM TECHNOLOGY LTD, Rapperswil-Jona (CH)

(72) Inventors: Moussa Baalbaki, Moriken (CH); Suz-Chung Ko, Lenzburg (CH)

(21) Appl. No.: 14/347,725

(22) PCT Filed: Sep. 27, 2012
(86) PCT No.: PCT/IB2012/001901

§ 371 Date: Mar. 27, 2014

(30) Foreign Application Priority Data
Sep. 29, 2011 (AT) A 1414/2011

(51) Int. Cl. C04B 24/24; C04B 24/32

(52) U.S. Cl. CPC C04B 24/24; C04B 24/32
USPC 106/790; 106/810

(57) ABSTRACT

Method for the production of a building material, in particular mortar or concrete from an alkali activated hydraulic binder, in which at least one dispersing agent and at least one set modifier is added to the mix, in which at least the dispersing agent is added after mixing the binder with water.

The present invention relates to a method for the production of a building material, in particular mortar or concrete from an alkali activated hydraulic binder, in which at least one dispersing agent and at least one set modifier is added to the mix.

Alkali activated aluminium silicate binders (AAAS) are cement-like materials, that are formed by converting fine-grained silica- and alumina-solids with an alkali- or alkali-salt solution for forming gels and crystalline compounds.

During alkali activation a high concentration of OH-ions in the mixture acts on the aluminium silicates. While in Portland-cement paste due to the solubility of calcium hydroxide a pH-value of greater than 12 is attained, the pH-value in the AAAS-system is even greater than 13.5. The amount of alkali, normally being in the range of 2 to 25% (w/w) alkali (>3% (w/w) Na₂O), depends on the alkalinity of the aluminium silicates.

The reactivity of an AAAS-binder depends on its chemical and mineral composition, the degree of vitrification and the fineness of grinding. In general, AAAS-binders start to set within 15 minutes and on the long run offer rapid curing and considerable increase in strength. The setting reaction and the curing process are not yet fully understood.

For producing high strength and durable building materials it is required to keep a relatively low water/binder-ratio when mixing the building material, so that particularly dense and thus strong crystal structures result from the curing of the alkali activated binder. A low water/binder-ratio involves the drawback that the building material provides unfavourable rheological properties. The flowability of the building materials prior to setting is rather poor in such building materials so that the casting or spraying of such building materials can only be carried out in a limited manner or not at all.

The addition of dispersing agents and set modifiers to hydraulic binders has been known for a long time and there are different approaches to influence the rheological properties, the duration of workability as well as the setting properties with respect to the strength values that can be reached with the building material—as a rule concrete or mortar—produced with the respective binders, according to varying requirements by the addition of these compounds.

Set modifiers provide a delay in the setting of the cement and hence allow for an extension of the workability of concrete.

Dispersing agents, also called concrete-liquefiers, flow agents, plasticizers or super-plasticizers are deployed in order to improve workability with regard to flowability. These additives are long chained organic molecules, that group around the cement particles and thus either bring about electrostatic repulsion between the particles or steric stabilisation of the particles, thereby increasing flowability of the building material. At pH-values prevailing in alkali activated hydraulic binders most of the known dispersing agents however are not stable, so that the known addition does not yield the desired results and moreover often brings about reduced values of end-strength.

It is hence an object of the present invention to improve a method of the initially mentioned kind to the extent that also when using alkali activated hydraulic binders improved workability or flowability can be achieved without decreasing end-strength inappropriately. The invention shall result in workability and desirable strength values even at a low water/binder-ratio of <0.5, in particular <0.45.

To solve this object, a method of the initially mentioned kind, according to the invention, is developed such that at least the dispersing agent is added after the steps of mixing the binder with water. This means that first of all the hydraulic binder is thoroughly mixed with water until a homogenous mass is formed and that only afterwards the dispersing agent is added. Applicant has observed that the inventive delayed addition of the dispersing agent provides for appropriate flowability and sufficient strength values.

It is important for the present invention that the addition of at least the dispersing agent is carried out only after the mixing step. In doing so it is preferred that the dispersing agent and, optionally, the set modifier is added 2 to 60 minutes, in particular 3 to 10 minutes after the step of mixing the binder with water, in particular after the end of the addition of the water.

According to a preferred embodiment of the present invention, the method is devised such that the dispersing agent and the set modifier are added simultaneously. This means that the dispersing agent and the set modifier are added at the same time, but in any case only after the step of mixing the binder with water, wherein it is preferred to add the dispersing agent and the set modifier 2 to 5 minutes, in particular 3 minutes after the step of mixing the binder with the water, in particular after the addition of water. In doing so, particular advantageous results were achieved as will be exemplified below.

Referring to a further advantageous embodiment of the present invention it is provided to add the set modifier together with the water when mixing the binder and to add the dispersing agent 30 to 60 minutes, in particular 40 to 50 minutes, in particular 45 minutes after the step of mixing the binder with the water. Also with this procedure satisfying results were achieved.

Preferably the dispersing agent is selected from the group consisting of melamine sulfonate polycondensates, polynapthalene-sulphonatepolycodensates and polycarboxylate ethers. These are known and commercially available dispersing agents that surprisingly provide, when proceeded as described, the desired properties with regard to flowability, i.e. workablility also in alkali activated binders.

On the other hand, the set modifier is preferably selected from the group consisting of modified salts of lignosulphate acids, in particular Na—, Ca— or NH₄ salts, salts of hydroxycarboxylic acids, in particular Na—, Ca— or Triethanolamine salts of adipic-, gluconic-, tartric-, succinic-, citric- and heptonic acid, carbohydrates as well as polysaccharides and their derivatives.

In the course of the experiments that have brought about the findings of the present invention, it has turned out to be of advantage if the set modifier and/or the dispersing agent is added in amounts of 0.025 to 1.5% (w/w), in particular 0.25 to 1.5% (w/w) in relation to the binder.

For achieving the early strength and the end-strength as well as the durability desired in the present invention, it is preferred to mix the building material with a water/binder-ratio of less than 0.5, in particular with a water/binder-ratio of less than 0.45.

In principle, the inventive method can be applied to all building materials on the basis of alkali activated binders. It is however particularly preferred that the hydaulic binder essentially consists of slag, in particular blast furnace slag in amounts of ≧20% (w/w), aluminium silicates different from blast furnace slag, preferably fly ash and natural aluminium silicates, preferably basalts, clays, marl, andesites or zeolithes, in amounts of 5% (w/w) to 75% (w/w) and an alkali activator in an amount corresponding to an Na₂O equivalent defined as (Na₂O+0.658 K₂O) (ASTM C 150) between 0.7% (w/w) and 4% (w/w). Such a building material is for example disclosed in EP 1735252 B1 of the applicant.

The invention is described in the following in more detail by way of exemplary and comparative examples. In all the examples an alkali activated hydraulic binder having the following composition is used as binder:

| | % (w/w) |
|---|---|
| Ground blast furnace slag | 90 |
| Na₂CO₃ | 5 |
| Portland Cement | 5 |

This binder was mixed with water in a water/binder ratio (W/B) of 0.45.

### EXAMPLE 1

| | |
|---|---|
| Binder [% (w/w)] | 100 |
| Set modifier [% (w/w)] | 0 |
| Dispersing agent [% (w/w)] | 0 |
| Addition time set modifier [min] *) | — |
| Addition time dispersing agent [min] *) | — |
| W/B | 0.45 |
| Workability after 10 min | 157 |
| Workability after 45 min | 124 |
| Compressive strength after 1 day [MPa] | 13.22 |
| Compressive strength after 2 days [MPa] | 22.28 |
| Compressive strength after 28 days [MPa] | 45.20 |

*) time after addition of water

Workability was determined according to the HolcimCone™ Flow-Method. This method uses a modified cone to measure the slump of fresh mortar samples, which correlates well to the slump of the concrete. The cone in this method is half as high as the cone in the method according to ASTM C 143.

### EXAMPLE 2

| | |
|---|---|
| Binder [% (w/w)] | 100 |
| Set modifier [% (w/w)] | 0.75 |
| Dispersing agent [% (w/w)] | 0 |
| Addition time set modifier [min] *) | 3 |
| Addition time dispersing agent [min] *) | — |
| W/B | 0.45 |
| Workability after 10 min | 187 |
| Workability after 45 min | 197 |
| Compressive strength after 1 day [MPa] | 9.9 |
| Compressive strength after 2 days [MPa] | 18.4 |
| Compressive strength after 28 days [MPa] | 41.0 |

### EXAMPLE 3

| | |
|---|---|
| Binder [% (w/w)] | 100 |
| Set modifier [% (w/w)] | 0 |
| Dispersing agent [% (w/w)] | 1.0 |
| Addition time set modifier [min] *) | — |
| Addition time dispersing agent [min] *) | 3 |
| W/B | 0.45 |
| Workability after 10 min | 212 |
| Workability after 45 min | 145 |
| Compressive strength after 1 day [MPa] | 12.7 |
| Compressive strength after 2 days [MPa] | 20.6 |
| Compressive strength after 28 days [MPa] | 39.6 |

### EXAMPLE 4

| | |
|---|---|
| Binder [% (w/w)] | 100 |
| Set modifier [% (w/w)] | 0.75 |
| Dispersing agent [% (w/w)] | 1.0 |
| Addition time set modifier [min] *) | 3 |
| Addtion time dispersing agent [min] *) | 3 |
| W/B | 0.45 |
| Workability after 10 min | 272 |
| Workability after 45 min | 255 |
| Compressive strength after 1 day [MPa] | 8.1 |
| Compressive strength after 2 days [MPa] | 16.8 |
| Compressive strength after 28 days [MPa] | 37.7 |

### EXAMPLE 5

| | |
|---|---|
| Binder [% (w/w)] | 100 |
| Set modifier [% (w/w)] | 0.75 |
| Dispersing agent [% (w/w)] | 1.0 |
| Addition time set modifier [min] *) | 0 |
| Addition time dispersing agent [min] *) | 0 |
| W/B | 0.45 |
| Workability after 10 min | 256 |
| Workability after 45 min | 263 |
| Compressive strength after 1 day [MPa] | 6.5 |
| Compressive strength after 2 days [MPa] | 12.7 |
| Compressive strength after 28 days [MPa] | 32.3 |

### EXAMPLE 6

| | |
|---|---|
| Binder [% (w/w)] | 100 |
| Set modifier [% (w/w)] | 0.75 |
| Dispersing agent [% (w/w)] | 1.0 |
| Addition time set modifier [min] *) | 0 |
| Addition time dispersing agent [min] *) | 45 |
| W/B | 0.45 |
| Workability after 10 min | 199 |
| Workability after 45 min | 257 |
| Compressive strength after 1 day [MPa] | 8.0 |
| Compressive strength after 2 days [MPa] | 15.3 |
| Compressive strength after 28 days [MPa] | 35.8 |

### EXAMPLE 7

| | |
|---|---|
| Binder [% (w/w)] | 100 |
| Set modifier [% (w/w)] | 0.75 |
| Dispersing agent [% (w/w)] | 1.0 |
| Addition time set modifier [min] *) | 45 |
| Addition time dispersing agent [min] *) | 0 |
| W/B | 0.45 |
| Workability after 10 min | 191 |
| Workability after 45 min | 248 |
| Compressive strength after 1 day [MPa] | 3.3 |
| Compressive strength after 2 days [MPa] | 17.7 |
| Compressive strength after 28 days [MPa] | 45.7 |

In all the examples the % (w/w) values are in relation to the binder.

In all the examples Na-lignosulfonate was used as set modifier and Polycarboxylate-ether as dispersing agent. Comparable examples can, however, be observed with other set modifiers and dispersing agents.

The above examples were carried out in order to determine under which conditions a workability of more than 250 mm after 45 min, a compressive strength of more than 8 MPa after 1 day (early strength) and a compressive strength of more than 35 MPa after 28 days (end strength) can be achieved.

The examples show that the desired workability cannot be achieved when neither a dispersing agent nor a set modifier (example 1), only a set modifier (example 2), or only a dispersing agent (example 3), are used. The desired workability can only be achieved when a dispersing agent as well as a set modifier are used (examples 4 to 7). However, in this case the timepoint of the addition of the dispersing agent and the set modifier have to be carefully chosen in order to achieve sufficient strength. Example 5 shows that the addition of dispersing agent and set modifier together with water leads to strength values that are significantly below the objective. With the inventive delayed addition of the set modifier and the dispersing agent however satisfactory strength values are achieved (example 4). If the set modifier is added in a usual manner together with the water, it is advantageous to add the dispersing agent as late as possible, for example directly at the construction site, for achieving the objective for the strength values (see example 6 according to the invention). Example 7 shows that in the case of conventional addition of the dispersing agent together with water workability can be improved by the addition of the set modifier. However, the early strength values are not satisfactory also when adding the set modifier very late.

It has been shown that only the inventive method of addition according to examples 4 and 6 is capable of fulfilling the objectives for workability and strength.

1. A method for the production of a building material comprising providing an alkali activated hydraulic binder and mixing the hydraulic binder with water in order to obtain a mixture, said mixture containing at least one dispersing agent selected from the group consisting of melamine sulfonate polycondensates, polynapthalene-sulphonatepolycondensates and polycarboxylate ethers, and at least one set modifier selected from the group consisting of modified salts of lignosulphate acids, salts of hydroxycarboxylic acids, carbohydrates as well as polysaccharides and their derivatives, wherein at least the dispersing agent is added after the step of mixing the binder with water.

2. The method according to claim 1, wherein the dispersing agent and, optionally, the set modifier is added 2 to 60 minutes after the step of mixing the binder with water.

3. The method according to claim 1, wherein the dispersing agent and the set modifier are added simultaneously.

4. The method according to claim 3, wherein the dispersing agent and the set modifier are added 2 to 5 minutes after the step of mixing the binder with the water.

5. The method according to claim 1, wherein the set modifier is added together with the water when mixing the binder and the dispersing agent is added 30 to 60 minutes after the step of mixing the binder with the water.

6. The method according to claim 1, wherein the set modifier and/or the dispersing agent is added in amounts of 0.025 to 1.5% (w/w) in relation to the binder.

7. The method according to claim 1, wherein the mixture has a water/binder-ratio of less than 0.5.

8. The method according to claim 1, wherein the binder essentially consists of slag in amounts of ≧20% (w/w), aluminium silicates different from blast furnace slag, in amounts of 5% (w/w) to 75% (w/w) and an alkali activator in an amount corresponding to an Na₂O equivalent (defined as Na₂O+0.658 K₂O) (ASTM C 150) between 0.7% (w/w) and 4% (w/w).

9. The method according to claim 1, wherein the dispersing agent and, optionally, the set modifier is added with 3 to 10 minutes after the step of mixing the binder with water.

10. The method according to claim 3, wherein the dispersing agent and the set modifier are added 3 minutes after the step of mixing the binder with water.

11. The method according to claim 1, wherein the set modifier is added together with the water when mixing the binder and the dispersing agent is added 40 to 50 minutes after the step of mixing the binder with the water.

12. The method according to claim 1, wherein the set modifier and/or the dispersing agent is added in amount of 0.25 to 1.5% (w/w) in relation to the binder.

13. The method according to claim 1, wherein the mixture has a water/binder-ratio of less than 0.45.

14. The method according to claim 1, wherein said set modifier is at least one modified salt of a lignosulphate acid selected from the group consisting of sodium, calcium and ammonium salts of the lignosulphate acid.

15. The method according to claim 1, wherein said set modifier is at least one salt of a hydroxycarboxylic acid wherein the hydroxycarboxylic acid is selected from the group consisting of adipic acid, gluconic acid, tartric acid, succinic acid, citric acid and heptonic acid.

16. The method according to claim 8, wherein said aluminium silicates different from blast furnace slag comprises a natural aluminium silicate selected from the group consisting of basalts, clays, marl, andesites or zeolites.
